(19) United States
(12) Patent Application Publication
(10) Pub. No.: US 2021/0294425 A1
(43) Pub. Date: Sep. 23, 2021

(54) METHOD FOR RECOGNIZING GESTURE AND GESTURE SENSING APPARATUS

(71) Applicants: LITE-ON ELECTRONICS (GUANGZHOU) LIMITED, GUANGZHOU (CN); Lite-On Technology Corporation, Taipei (TW)

(72) Inventors: Su-Chen Lin, Taipei (TW); Chun-Yen Chen, Taipei (TW)

(73) Assignees: LITE-ON ELECTRONICS (GUANGZHOU) LIMITED, GUANGZHOU (CN); Lite-On Technology Corporation, Taipei (TW)

(21) Appl. No.: 17/074,574

(22) Filed: Oct. 19, 2020

(30) Foreign Application Priority Data
Mar. 20, 2020 (CN) 202010200373.9

(51) Int. Cl. G06F 3/01; G06K 9/00; G01J 5/00

(52) U.S. Cl. CPC G06F 3/017; G01J 5/0025; G06K 9/00536; G06F 3/011

(57) ABSTRACT

A method for recognizing a gesture and gesture sensing apparatus are provided. When movement of an object is detected, a first energy sequence and a second energy sequence are generated. Then, whether signal patterns of the first energy sequence and the second energy sequence match is determined. After determining that the signal patterns of the first energy sequence match that of the second energy sequence, the first energy sequence and the second energy sequence are analyzed to obtain a corresponding gesture event.

### CROSS-REFERENCE TO RELATED APPLICATION

This application claims the priority benefit of Chinese patent application serial no. 202010200373.9, filed on Mar. 20, 2020. The entirety of the above-mentioned patent application is hereby incorporated by reference herein and made a part of this specification.

### BACKGROUND

### Field of the Disclosure

The disclosure relates to a sensing method and apparatus, and more particularly, to a gesture recognizing method and a gesture sensing apparatus.

### Description of Related Art

In conventional technology, infrared sensing elements have been utilized to detect infrared radiation emitted from human body, thereby detecting human movement. The technology is to sample analog signal, convert the infrared radiation value received by the sensing element into a signal, and further set a threshold value, and determine whether an object is approaching by determining whether the signal exceeds the threshold value. However, the method described above cannot determine complicated gesture events.

### SUMMARY OF THE DISCLOSURE

The disclosure provides a gesture recognizing method and a gesture sensing apparatus, calculating the energy of the sensed signal to confirm the signal pattern, and further determining the occurrence of different gesture events.

The gesture recognizing method in the disclosure includes: detecting the movement of an object to generate a first energy sequence and a second energy sequence; determining whether the signal patterns of the first energy sequence match that of the second energy sequence; and analyzing the first energy sequence and the second energy sequence to obtain a corresponding gesture event.

The gesture sensing apparatus of the disclosure includes: a signal sensing apparatus that detects the movement of an object to generate a first energy sequence and a second energy sequence; and a processor coupled to the signal sensing apparatus to receive the first energy sequence and the second energy sequence, wherein the processor determines whether the signal patterns of the first energy sequence match that of the second energy sequence, and analyzes the first energy sequence and second energy sequence to obtain a corresponding gesture event.

Based on the above, by calculating the energy sequence of the signal output by the signal sensing apparatus, the disclosure can make a more accurate and flexible judgment on signal patterns. In the meantime, when there are different signal patterns but the signal energy is the same, it is possible to perform further processing to obtain more accurate results.

### BRIEF DESCRIPTION OF THE DRAWINGS

FIG. 1 is a block view of a gesture sensing apparatus according to an embodiment of the disclosure.

FIG. 2 is a flowchart of a gesture recognizing method according to an embodiment of the disclosure.

FIG. 3 is a schematic view of a signal pattern when an object moves from the top to the bottom according to an embodiment of the disclosure.

FIG. 4 is a schematic view of a signal pattern when an object moves from the bottom to the top according to an embodiment of the disclosure.

FIG. 5 is a schematic view of a signal pattern when an object moves from left to right according to an embodiment of the disclosure.

FIG. 6 is a schematic view of a signal pattern when an object moves from right to left according to an embodiment of the disclosure.

FIG. 7 is a schematic view of state transition of a gesture sensing apparatus according to an embodiment of the disclosure.

FIG. 8 is a block view of a dimmer according to an embodiment of the disclosure.

FIG. 9 is a block view of a signal pre-processing module according to an embodiment of the disclosure.

### DESCRIPTION OF EMBODIMENTS

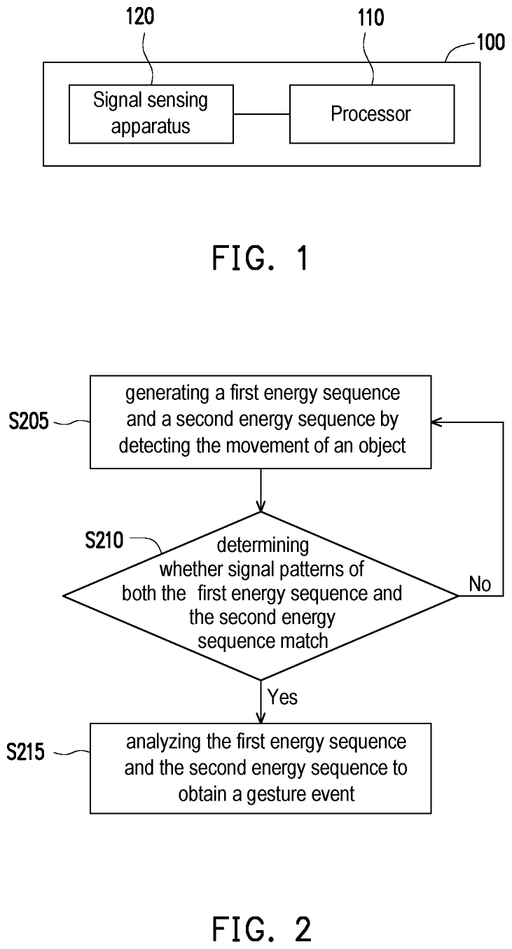

FIG. 1 is a block view of a gesture sensing apparatus according to an embodiment of the disclosure. In FIG. 1, a gesture sensing apparatus 100 includes a processor 110 and a signal sensing apparatus 120. The processor 110 is, for example, a Central Processing Unit (CPU), a Physical Processing Unit (PPU), a programmable microprocessor, an embedded control chip, a Digital Signal Processor (DSP), an Application Specific Integrated Circuit (ASIC) or other similar devices.

The signal sensing apparatus 120 is configured to detect the movement of objects. Here, the signal sensing apparatus 120 includes a plurality of sensors. The signal patterns output by the plurality of sensors are utilized to further determine the occurrence of different gesture events, which can achieve the functions of dimming and effective detection of object movement. In the case where a passive infrared sensor is utilized as the signal sensing apparatus 120, the signal sensing apparatus 120 absorbs external infrared radiation signals, which passes through Fresnel lens on the surface of the signal sensing apparatus 120, thereby generating positive and negative oscillation signals. The design of the placement of the plurality of sensors enables the plurality of sensors to generate a fixed signal output pattern under different gestures, thereby further determining the gesture event.

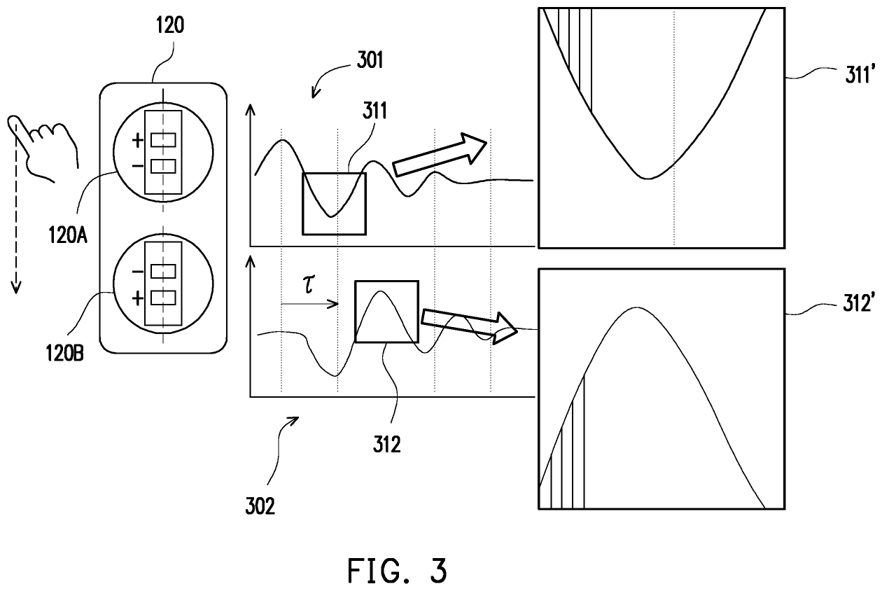

The gesture sensing apparatus 100 is utilized below to further explain the steps of the gesture recognizing method. FIG. 2 is a flowchart of a gesture recognizing method according to an embodiment of the disclosure. Please refer to FIG. 1 and FIG. 2. In step S205, the first energy sequence and the second energy sequence are generated by detecting the movement of the object through the signal sensing apparatus 120. The energy calculation method calculates the energy calculation of the signal sequence after sampling at the sampling frequency fs within the signal interval of a length N (as expressed by the following formula (1)).

$$E = \frac{1}{f s} {\sum }_{n = 0}^{N} {\vert x [ n ] \vert}^{2} \qquad Formula ( 1 )$$

wherein E is the energy, fs is the sampling frequency, and N is the length of the signal interval.

For example, the signal sensing apparatus 120 includes two sensors. By performing energy calculations on the output signals of the two sensors respectively, the first energy sequence and the second energy sequence can be further obtained.

Next, in step S210, the processor 110 determines whether the signal patterns of the first energy sequence match that of the second energy sequence. After determining that the signal patterns of the first energy sequence match that of the second energy sequence, as shown in step S215, the processor 110 analyzes the first energy sequence and the second energy sequence to obtain a corresponding gesture event.

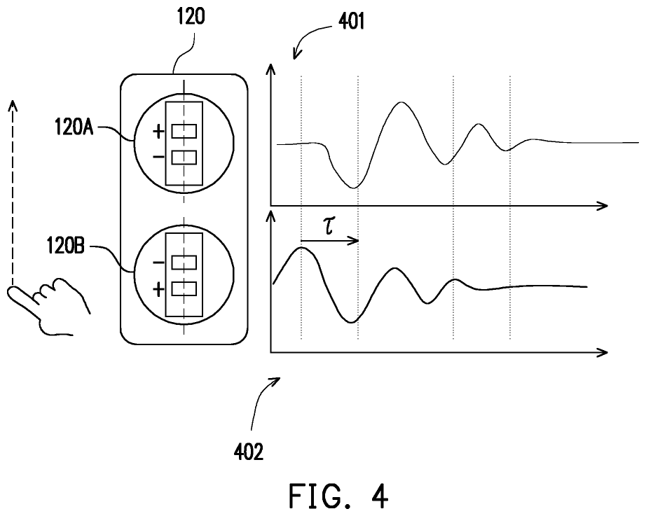

FIG. 3 is a schematic view of a signal pattern when an object moves from the top to the bottom according to an embodiment of the disclosure. FIG. 4 is a schematic view of a signal pattern when an object moves from the bottom to the top according to an embodiment of the disclosure. In this embodiment, the signal sensing apparatus 120 includes a first sensor 120A and a second sensor 120B. The first sensor 120A and the second sensor 120B are utilized to detect the movement of the object in the first direction (for example, the up-down direction) to generate the first energy sequence and the second energy sequence, respectively.

In FIG. 3, when an object (such as a hand) moves from the top to the bottom of the signal sensing apparatus 120, the first sensor 120A outputs the first energy sequence 301, and the second sensor 120B outputs the second energy sequence 302. The first energy sequence 301 and the second energy sequence 302 are upside-down signal patterns, and there is a delay time τ between the signal patterns of the first energy sequence 301 and the second energy sequence 302. In FIG. 3, the box 311′ and the box 312′ are enlarged views of the box 311 and the box 312, respectively. By comparing the signal patterns in the box 311′ and the box 312′, it can be obtained that they are upside-down signal patterns.

In FIG. 4, when an object (such as a hand) moves from the bottom to the top of the signal sensing apparatus 120, the first sensor 120A outputs the first energy sequence 401, and the second sensor 120B outputs the second energy sequence 402. The first energy sequence 401 and the second energy sequence 402 are another upside-down signal patterns, and there is a delay time τ between the signal patterns of the first energy sequence 401 and the second energy sequence 402.

Take FIG. 3 as an example to explain how to determine whether the signal patterns of the first energy sequence 301 match that of the second energy sequence 302. Please refer to FIG. 3, M first sampling signals are taken from the first energy sequence 301, and M second sampling signals are taken from the second energy sequence 302 after the delay time τ has elapsed. That is, corresponding to the time point when the first sampling signals are taken from the first energy sequence 301, the second sampling signals are taken from the second energy sequence 302 after the delay time τ has passed, wherein M is a signal pattern length, there are different signal pattern lengths for different gesture signals. Then, the M first sampling signals and the M second sampling signals are compared to obtain M energy differences; and when the M energy differences are all smaller than or equal to a threshold value, it is determined that the signal patterns of the first energy sequence 301 match that of the second energy sequence 302.

The energies E₁(0) to E₁(M−1) of the M first sampling signals and the energies E₂(τ) to E₂(M−1+τ) of the M second sampling signals are calculated based on the formula (1). Then, the energy difference is compared to a threshold value.

That is, in the condition where |E₁[0]−E₂[τ]≤Th, |E₁[1]−E₂[1+τ]|≤Th, |E₁[2]−E₂[2+τ]|≤Th, . . . |E₁[M−1]−E₂ [M−1+τ]|≤Th, it is determined that the signal patterns of the first energy sequence 301 match that of the second energy sequence 302.

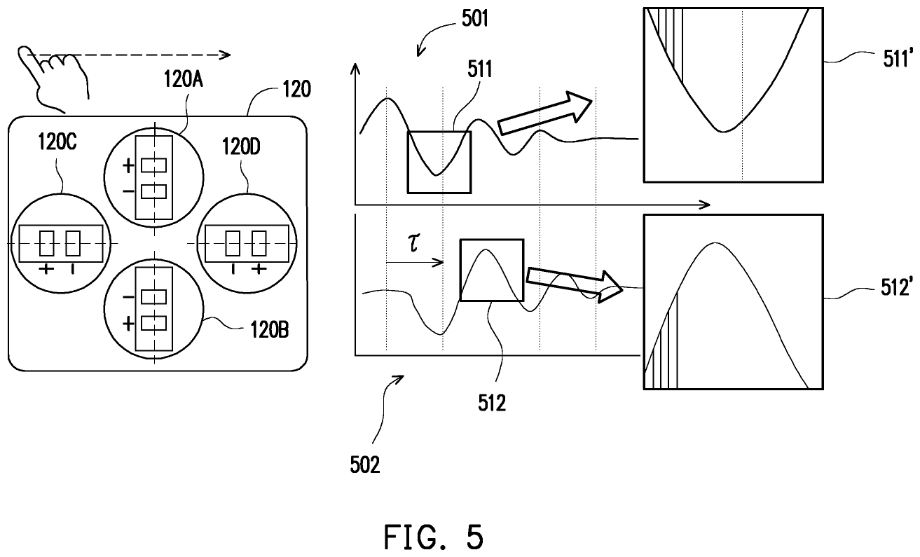

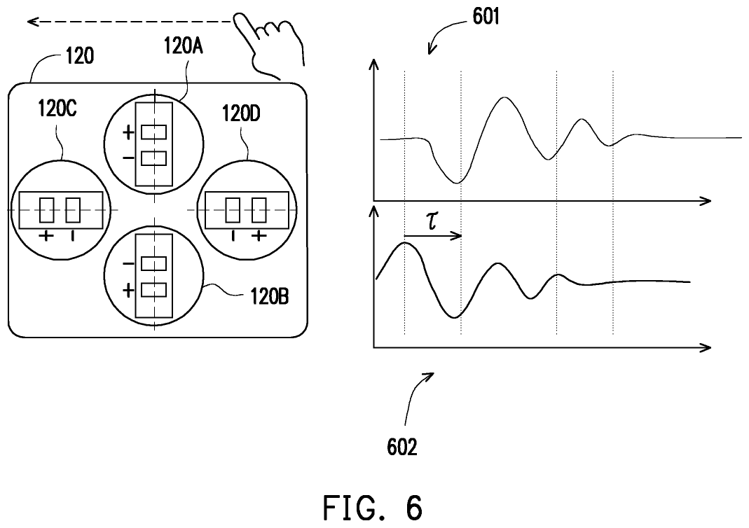

FIG. 5 is a schematic view of a signal pattern when an object moves from left to right according to an embodiment of the disclosure. FIG. 6 is a schematic view of a signal pattern when an object moves from right to left according to an embodiment of the disclosure. In the embodiment, the signal sensing apparatus 120 includes a first sensor 120A, a second sensor 120B, a third sensor 120C, and a fourth sensor 120D. In the embodiments of FIG. 5 and FIG. 6, in addition to using the first sensor 120A and the second sensor 120B to detect the movement of the object in the first direction (for example, the up-down direction) to generate the first energy sequence and the second energy sequence respectively, the third sensor 120C and the fourth sensor 120D are also utilized to detect the movement of the object in the second direction (for example, the left-right direction) to generate the third energy sequence and the fourth energy sequence respectively.

In FIG. 5, when an object (such as a hand) moves from the left to the right of the signal sensing apparatus 120, the third sensor 120C outputs the third energy sequence 501, and the fourth sensor 120D outputs the fourth energy sequence 502. The third energy sequence 501 and the fourth energy sequence 502 are upside-down signal patterns, and there is a delay time τ between the signal patterns of the third energy sequence 501 and the fourth energy sequence 502. In FIG. 5, the box 511′ and the box 512′ are enlarged views of the box 511 and the box 512, respectively. By comparing the signal patterns in the box 511′ and the box 512′, it can be obtained that they are upside-down signal patterns.

In FIG. 6, when an object (such as a hand) moves from the right to the left of the signal sensing apparatus 120, the third sensor 120C outputs the third energy sequence 601 and the fourth sensor 120D outputs the fourth energy sequence 602. The third energy sequence 601 and the fourth energy sequence 602 are upside-down signal patterns, and there is a delay time τ between the signal patterns of the third energy sequence 601 and the fourth energy sequence 602.

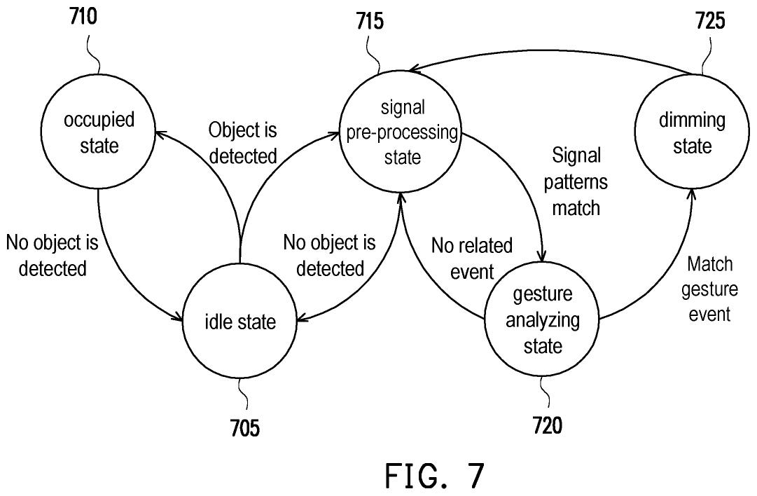

FIG. 7 is a schematic view of state transition of a gesture sensing apparatus according to an embodiment of the disclosure. Please refer to FIG. 7. In this embodiment, the gesture sensing apparatus 100 is used as the dimming apparatus. Also, the gesture sensing apparatus 100 includes an idle state 705, an occupied state 710, a signal pre-processing state 715, a gesture analyzing state 720, and a dimming state 725.

When the signal sensing apparatus 120 of the gesture sensing apparatus 100 is in the state of detecting nothing, the gesture sensing apparatus 100 is in the idle state 705. When the signal sensing apparatus 120 detects an object, the gesture sensing apparatus 100 enters the occupied state 710 and also enters the signal pre-processing state 715. When the gesture sensing apparatus 100 is in the signal pre-processing state 715, when the signal patterns of the first energy sequence match that of the second energy sequence, the gesture sensing apparatus 100 enters the gesture analyzing state 720. When a matching gesture event is found in the gesture analyzing state 720, the gesture sensing apparatus 100 enters the dimming state 725 and performs the corresponding dimming operation. When no matching gesture event (no related event) is found in the gesture analyzing state 720, the gesture sensing apparatus 100 returns to the signal pre-processing state 715. In the signal pre-processing state 715, when the signal output by the signal sensing apparatus 120 has no energy change (indicating that no object is detected), the gesture sensing apparatus 100 returns to the idle state 705, and waits for the next sensing signal generated by the signal sensing apparatus 120. In the meantime, in the signal pre-processing state 715, the signal sensing apparatus 120 is in a state of continuously generating a signal and performs energy calculation to obtain an energy sequence (first energy sequence to fourth energy sequence, etc.) until the signal stays stable and unchanged.

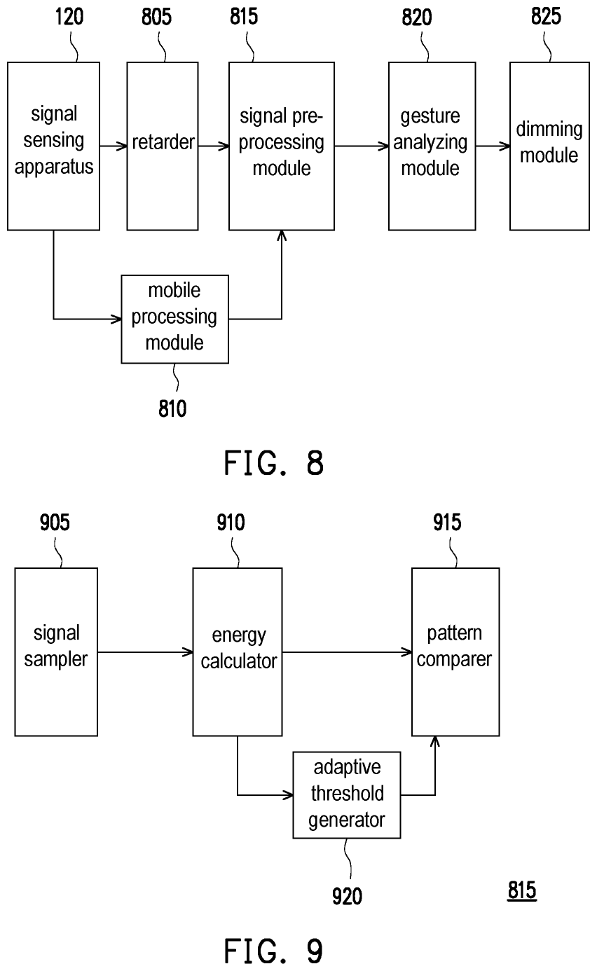

FIG. 8 is a block view of a dimmer according to an embodiment of the disclosure. In this embodiment, the gesture sensing apparatus 100 is utilized as a dimming apparatus to perform dimming processing. Specifically, a plurality of modules are stored in the memory of the gesture sensing apparatus 100, and these modules are executed by the processor 110 to recognize gestures and further adjust dimming. These modules include a retarder 805, a mobile processing module 810, a signal pre-processing module 815, a gesture analyzing module 820, and a dimming module 825.

In FIG. 8, the signal sensing apparatus 120 is utilized to determine whether to enter the signal pre-processing state 715 or whether to return to the idle state 705. The retarder 805 provides a delay time τ for the signal output by the signal sensing apparatus 120. Here, the retarder 805 can perform delay processing according to different signal strengths, thereby adjusting different delay times for the signal pre-processing module 815 to calculate and determine the signal pattern.

The mobile processing module 810 is configured to determine whether the gesture sensing apparatus 100 enters the occupied state 710. For example, when the signal sensing apparatus 120 detects an object, it is determined that there is an object moving, so the gesture sensing apparatus 100 enters the occupied state 710.

The signal pre-processing module 815 is configured to process the signal output by the signal sensing apparatus 120 to determine the signal pattern. FIG. 9 is a block view of a signal pre-processing module according to an embodiment of the disclosure. The signal pre-processing module 815 includes a signal sampler 905, an energy calculator 910, a pattern comparator 915, and an adaptive threshold generator 920. The signal sampler 905 is configured to process the sampling of continuous signals. The energy calculator 910 is configured to calculate the energy of the signal after sampling.

For example, the signal sampler 905 utilizes two sensors to output a first sensing signal and a second sensing signal. The signal sampler 905 samples the signal at a sampling frequency in a signal interval of a length N in the first sensing signal and the second sensing signal, respectively. Then, the energy calculator 910 calculates the energy of the first sensing signal and the energy of the second sensing signal respectively after sampling based on the formula (1), and further obtains the first energy sequence and the second energy sequence. After the energy calculation, the pattern comparer 915 is utilized to compare whether the signal patterns of the first energy sequence match that of the second energy sequence. The pattern comparator 915 can also adjust the delay time τ simultaneously to achieve a more complete signal pattern.

After the energy calculator 910 completes the energy calculation, the energy calculator 910 further determines whether the energy difference between the first sensing signal and the second sensing signal after the delay time is smaller than a threshold value. In the signal pattern comparator, the energy of M signals is continuously sampled from the first sensing signal and the second sensing signal for comparison. If the M energy differences obtained are smaller than or equal to the threshold value after comparison, it is determined that the pattern comparison is successful, and the gesture analyzing module 820 is entered to perform a gesture event comparison.

The adaptive threshold generator 920 is configured to generate the threshold value for comparison with the energy difference and the delay time by using the adaptive threshold method. After the energy calculator 910 calculates the energy, the calculation result is input to the adaptive threshold generator 920 to generate the optimal threshold value and delay time. The optimal threshold value can be generated through intelligent algorithms, such as, Minimum Mean Squared Error (MSE), Least Mean Square (LMS), Neural Network, Particle Swarm Optimization (PSO) and other intelligent algorithms, the disclosure is not limited thereto. The threshold value is configured for signal energy pattern comparison. After determining that the signal patterns of the first energy sequence match that of the second energy sequence, the gesture event is further determined.

The gesture analyzing module 820 is configured to perform comparison according to a specific signal pattern after the signal pre-processing module 815 completes processing. If the comparison result is match, the dimming module 825 is provided to further complete the event corresponding to the signal pattern. Specifically, the gesture analyzing module 820 analyzes the first energy sequence and the second energy sequence to obtain a corresponding gesture event. For example, the gesture analyzing module 820 analyzes the first energy sequence 301 and the second energy sequence 302 shown in FIG. 3, and the obtained gesture event is sliding from the top to the bottom. The gesture analyzing module 820 analyzes the first energy sequence 401 and the second energy sequence 402 shown in FIG. 4, and the obtained gesture event is sliding from the bottom to the top. After obtaining a gesture event, the dimming module 825 will trigger a relative event.

In addition, when the user uses the gesture sensing apparatus 100 for the first time, the threshold value and the delay time can be further calculated through a correction mode. For example, after the user finishes installing the gesture sensing apparatus 100, the correction mode is entered first, and the energy is further detected and calculated with respect to the user's gesture, thereby adjusting the threshold value and the delay time. In this way, the gesture sensing apparatus 100 can be optimized to adjust the threshold value and the delay time according to gestures of different users, thereby achieving a more accurate gesture detecting event. Through the correction mode, different gestures can correspond to different signal pattern lengths. In the meantime, when the user performs a gesture test, the signal sensing apparatus 120 can further determine the selection of the signal pattern length M through the signal change. If the signal has no change after the gesture is completed, the signal pattern length M ends.

In summary, by calculating the energy sequence of the signal output by the signal sensing apparatus, the disclosure can make a more accurate and flexible judgment on signal patterns. In the meantime, when there are different signal patterns but the signal energy is the same, it is possible to perform further processing to obtain more accurate results.

What is claimed is:

1. A gesture recognizing method, comprising:
detecting a movement of an object to generate a first energy sequence and a second energy sequence;
determining whether signal patterns of the first energy sequence match that of the second energy sequence; and
after determining that the signal patterns of the first energy sequence match that of the second energy sequence, analyzing the first energy sequence and the second energy sequence to obtain a corresponding gesture event.

2. The gesture recognizing method according to claim 1, wherein the step of determining whether the signal patterns of the first energy sequence match that of the second energy sequence further comprises:
taking M first sampling signals from the first energy sequence;
taking M second sampling signals from the second energy sequence after a delay time;
comparing the M first sampling signals and the M second sampling signals to obtain M energy differences; and
when the M energy differences are all smaller than or equal to a threshold value, determining that the signal patterns of the first energy sequence match that of the second energy sequence.

3. The gesture recognizing method according to claim 2, further comprising:
utilizing an adaptive threshold method to obtain the threshold value and the delay time.

4. The gesture recognizing method according to claim 1, further comprising:
utilizing a first sensor and a second sensor to detect the movement of the object in a first direction to generate the first energy sequence and the second energy sequence, respectively.

5. The gesture recognizing method according to claim 4, further comprising:
utilizing a third sensor and a fourth sensor to detect the movement of the object in a second direction to generate a third energy sequence and a fourth energy sequence, respectively;
determining whether signal patterns of the third energy sequence match that of the fourth energy sequence; and
after determining that the signal patterns of the third energy sequence match that of the fourth energy sequence, analyzing the third energy sequence and the fourth energy sequence to obtain another gesture event corresponding to the object.

6. A gesture sensing apparatus, comprising:
a signal sensing apparatus, detecting a movement of an object to generate a first energy sequence and a second energy sequence; and
a processor, coupled to the signal sensing apparatus to receive the first energy sequence and the second energy sequence, wherein the processor determines whether signal patterns of the first energy sequence match that of the second energy sequence, after determining that the signal patterns of the first energy sequence match that of the second energy sequence, the first energy sequence and the second energy sequence are analyzed to obtain a corresponding gesture event.

7. The gesture sensing apparatus according to claim 6, wherein the processor takes M first sampling signals from the first energy sequence and takes M second sampling signals from the second energy sequence after a delay time, and compares the M first sampling signals with the M second sampling signals to obtain M energy differences, when the M energy differences are all smaller than or equal to a threshold value, it is determined that the signal patterns of the first energy sequence match that of the second energy sequence.

8. The gesture sensing apparatus according to claim 7, further comprising:
an adaptive threshold generator coupled to the processor,
wherein the processor executes the adaptive threshold generator to generate the threshold value and the delay time.

9. The gesture sensing apparatus according to claim 6, wherein the signal sensing apparatus comprises a first sensor and a second sensor,
the first sensor and the second sensor are utilized to detect the movement of the object in a first direction to generate the first energy sequence and the second energy sequence, respectively.

10. The gesture sensing apparatus according to claim 9, wherein the signal sensing apparatus further comprises: a third sensor and a fourth sensor,
the third sensor and the fourth sensor are utilized to detect the movement of the object in a second direction to generate a third energy sequence and a fourth energy sequence, respectively;
the processor determines whether signal patterns of the third energy sequence match that of the fourth energy sequence, and after determining that the signal patterns of the third energy sequence match that of the fourth energy sequence, the third energy sequence and the fourth energy sequence are analyzed to obtain another gesture event corresponding to the object.
